(19) United States
(12) Patent Application Publication
(10) Pub. No.: US 2018/0132472 A1
(43) Pub. Date: May 17, 2018

(54) Weed Spraying System

(71) Applicant: Thomas George, Vooheesville, NY (US)

(72) Inventor: Thomas George, Vooheesville, NY (US)

(21) Appl. No.: 15/353,801

(22) Filed: Nov. 17, 2016

(51) Int. Cl. A01M 21/04; B05B 15/04

(52) U.S. Cl. CPC A01M 21/043; B05B 15/0443

(57) ABSTRACT

A weed spraying system for precisely spraying a liquid herbicide includes a sprayer that has a wand and a spray nozzle. The spray nozzle selectively sprays a liquid onto a plant. A shield is removably coupled to the wand. The shield is aligned with the nozzle to inhibit the liquid from spraying past the shield. In this way the liquid may be applied on a selected spot.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to spraying devices and more particularly pertains to a new spraying device for precisely spraying a liquid herbicide.

### BRIEF SUMMARY OF THE INVENTION

An embodiment of the disclosure meets the needs presented above by generally comprising a sprayer that has a wand and a spray nozzle. The spray nozzle selectively sprays a liquid onto a plant. A shield is removably coupled to the wand. The shield is aligned with the nozzle to inhibit the liquid from spraying past the shield. In this way the liquid may be applied on a selected spot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shield of a weed spraying system according to an embodiment of the disclosure.

FIG. 2 is a front view of a shield of an embodiment of the disclosure.

FIG. 3 is a bottom view of a shield of an embodiment of the disclosure.

FIG. 4 is a perspective in-use view of an embodiment of the disclosure.

### DETAILED DESCRIPTION OF THE INVENTION

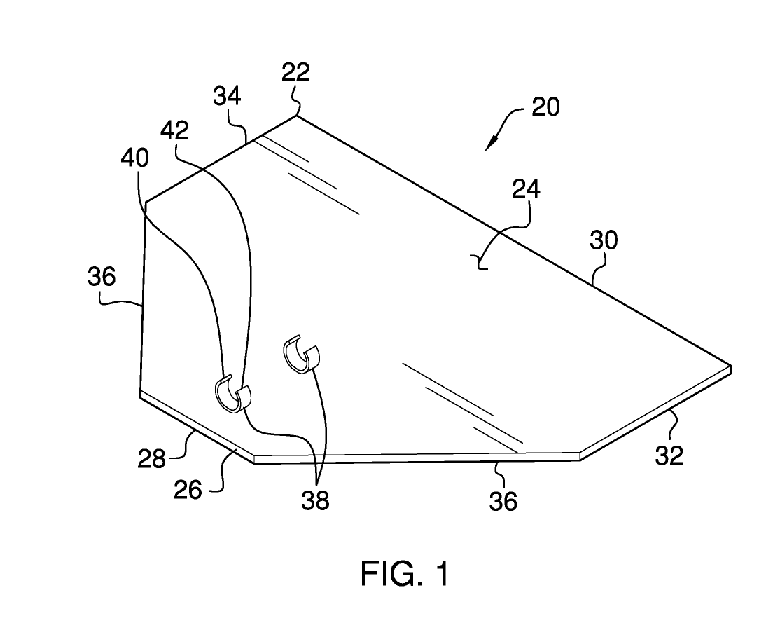

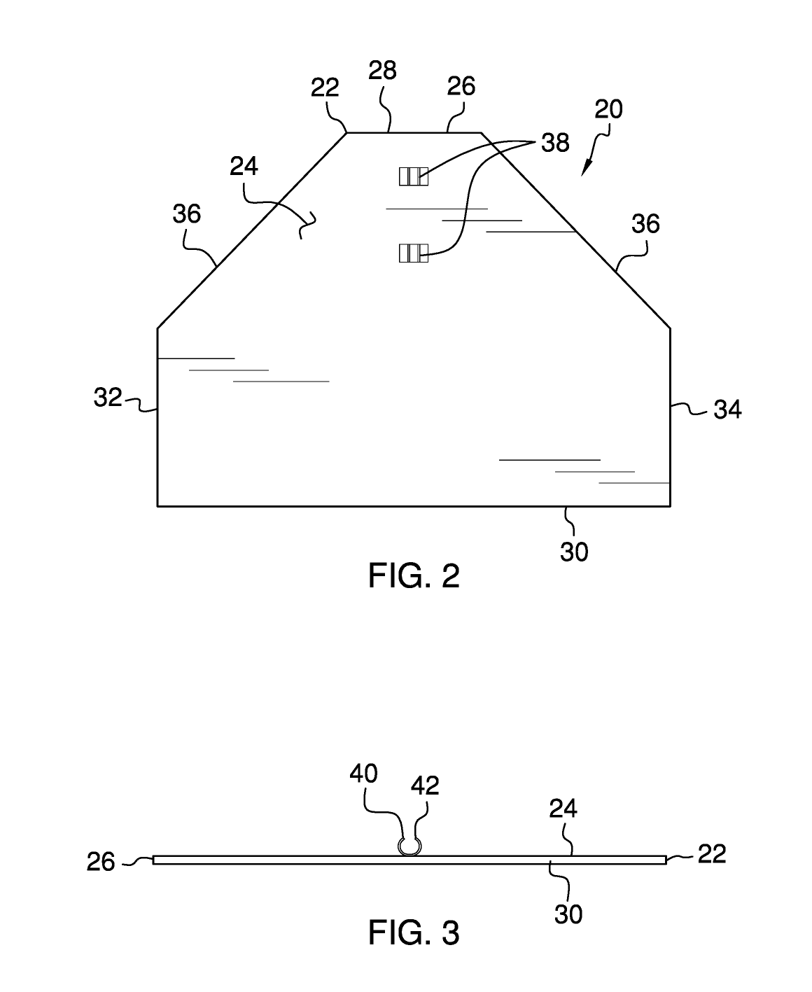

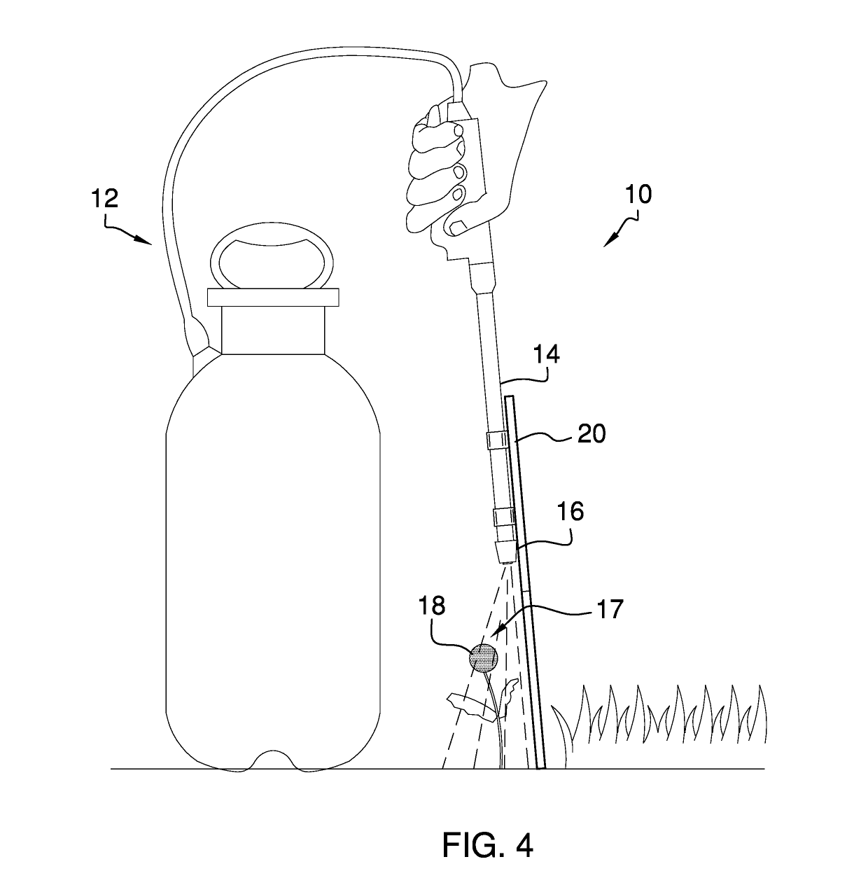

With reference now to the drawings, and in particular to FIGS. 1 through 4 thereof, a new spraying device embodying the principles and concepts of an embodiment of the disclosure and generally designated by the reference numeral 10 will be described.

As best illustrated in FIGS. 1 through 4, the weed spraying system 10 generally comprises a sprayer 12 that has a wand 14 and a spray nozzle 16. The spray nozzle 16 selectively sprays a liquid 17 onto a plant 18. The liquid 17 may be a liquid herbicide or the like and the plant 18 may be a weed in a lawn. The sprayer 12 may comprise a pressurized liquid sprayer of any conventional design.

A shield 20 is provided and the shield 20 is removably coupled to the wand 14. The shield 20 is aligned with the spray nozzle 16 to inhibit the liquid 17 from spraying past the shield 20. In this way the liquid 17 may be sprayed on a selected spot.

The shield 20 comprises a panel 22 that has a first surface 24 and a peripheral edge 26. The peripheral edge 26 has a top side 28, a bottom side 30, a first lateral side 32 and a second lateral side 34. The peripheral edge 26 has a pair of angled sides 36 and each of the angled sides 36 extends outwardly between the top side 28 and an associated one of the first lateral side 32 and the second lateral side 34. Thus, the top side 28 has a width that is less than a width of the bottom side 30.

A pair of clips 38 is provided and each of the clips 38 is coupled to the first surface 24. Each of the clips 38 has a first end 40 and a second end 42. Moreover, each of the clips 38 is curved such that the first end 40 of an associated one of the clips 38 is directed toward the second end 42 of the associated clip. The first end 40 and the second end 42 corresponding to each of the clips 38 are directed away from the panel 22. The clips 38 are spaced apart from each other and are distributed between the top side 28 and the bottom side 30. Each of the clips 38 is positioned closer to the top side 28 than the bottom side 30. Each of the clips 38 removably engages the wand 14 having the spray nozzle 16 being centrally positioned on the panel 22. In this way the first surface 24 of the panel 22 inhibits the liquid 17 from spraying past the panel 22.

In use, each of the clips 38 is attached to wand 14 such that the spray nozzle 16 is centrally positioned on the panel 22. The wand 14 is manipulated to position the bottom side 30 on or near ground having the plant 18 abutting the first surface 24 of the panel 22. In this way the spray nozzle 16 is positioned over the plant 18. The sprayer 12 is manipulated to spray the liquid 17 outwardly from the spray nozzle 16 and onto the plant 18. The panel 22 inhibits the liquid 17 from spraying past the plant 18. In this way the panel 22 facilitates precise application of the liquid 17 thereby inhibiting adjacent plants with respect to the panel 22 from being sprayed with the liquid 17.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A weed spraying system comprising:
a sprayer having a wand and a spray nozzle, said wand being elongated and cylindrical, said spray nozzle being configured to selectively spray a liquid onto a plant; and
a shield being removably coupled to said wand, said shield being aligned with said nozzle wherein said shield is configured to inhibit the liquid from spraying past said shield thereby facilitating the liquid to be applied on a selected spot, said shield comprising a panel having a first surface, a top side and a bottom side; and
a pair of clips, each of said clips being coupled directly to said first surface, each of said clips having a first end and a second end, each of said clips being curved such that said first end of an associated one of said clips is directed toward said second end of said associated clip, said wand of said sprayer being insertable into said clips wherein said wand is coupled to said panel in fixed parallel position relative to said panel.

2. The system according to claim 1, wherein said peripheral edge has a top side, a bottom side, a first lateral side and a second lateral side, said peripheral edge having a pair of angled sides, each of said angled sides extending outwardly between said top side and an associated one of said first lateral side and said second lateral side such that said top side has a width being less than a width of said bottom side.

3. (canceled)

4. The system according to claim 1, wherein said clips are spaced apart from each other and are distributed between said top side and said bottom side, each of said clips being positioned closer to said top side than said bottom side, each of said clips removably engaging said wand having said spray nozzle being centrally positioned on said panel wherein said first surface of said panel is configured to inhibit the fluid from spraying past said panel.

5. A weed spraying system comprising:
a sprayer having a wand and a spray nozzle, said wand being elongated and cylindrical, said spray nozzle being configured to selectively spray a liquid onto a plant; and
a shield being removably coupled to said wand, said shield being aligned with said nozzle wherein said shield is configured to inhibit the liquid from spraying past said shield thereby facilitating the liquid to be applied on a selected spot, said shield comprising:
a panel having a first surface and a peripheral edge, said peripheral edge having a top side, a bottom side, a first lateral side and a second lateral side, said peripheral edge having a pair of angled sides, each of said angled sides extending outwardly between said top side and an associated one of said first lateral side and said second lateral side such that said top side has a width being less than a width of said bottom side, and
a pair of clips, each of said clips being coupled directly to said first surface, each of said clips having a first end and a second end, each of said clips being curved such that said first end of an associated one of said clips is directed toward said second end of said associated clip, said clips being spaced apart from each other and being distributed between said top side and said bottom side, said wand of said sprayer being insertable into said clips wherein said wand is coupled to said panel in fixed parallel position relative to said panel, each of said clips being positioned closer to said top side than said bottom side, each of said clips removably engaging said wand having said spray nozzle being centrally positioned on said panel wherein said first surface of said panel is configured to inhibit the fluid from spraying past said panel.
